(19) United States
(12) Patent Application Publication
(10) Pub. No.: US 2007/0127747 A1
(43) Pub. Date: Jun. 7, 2007

(54) Conversation switch for stereo headphones

(76) Inventor: John Doyle, Timonium, MD (US)

Correspondence Address: Royal W. Craig;Ober, Kaler, Grimes & Shriver, 120 East Baltimore Street, Baltimore, MD, 21202-1643, US

(21) Appl. No.: 11/634,051

(22) Filed: Dec. 5, 2006

Related U.S. Application Data
(60) Provisional application No. 60/742,707, filed on Dec. 6, 2005.

(51) Int. Cl. H04R 5/02

(52) U.S. Cl. 381/309

(57) ABSTRACT

The present invention provides a very lightweight conversation switch for stereo headphones that allows a user to select between listening to an audio player's source (e.g. music player, computer) and listening to a microphone. The preferred embodiment comprises a standard earphone or headphone set with an additional electronics assembly interposed between the plug and earpieces. The electronics assembly includes a microphone, amplifier, momentary switch, and a latching DPDT relay. The momentary switch functions to toggle the internal relay between the audio source and the microphone amplifier, whereupon ambient sound is picked up by the microphone assembly and is amplified and output to the earphones. The length of cable from the switch assembly to the earpieces is predetermined to allow fixation of the switch assembly at a point situated directly in front of the chest when the user is standing or sitting.

### CROSS-REFERENCE TO RELATED APPLICATIONS

The present application derives priority from provisional patent application No. 60/742,707 filed Dec. 6, 2005.

### BACKGROUND OF THE INVENTION

(1) Field of the Invention

The present invention relates to portable consumer electronics that employ headphones and, more particularly, to a system and method for allowing a listener of a portable audio player to immediately converse without removing the earphones.

(2) Description of the Background

Portable audio players such as MP3 players, FM radios, satellite receivers and the like all require the use of stereo ear buds or headphones. However, those who listen via ear buds or headphones share a common problem. Their listening is often interrupted by others asking questions or desiring discourse, and the listener experiences great difficulty in trying to reply. To converse effectively, the listener must either stop the player or remove one or both earphones to hear. It would be far more convenient if the listener could simply activate a switch to suppress the sound of the portable audio player and replace it with the ambient speech. This would necessarily entail a microphone switchable into and out of the circuitry.

The general concept of a microphone and switch attached/incorporated into earphone cables, allowing listeners to leave earphones inserted and to switch from using an auxiliary device to a microphone with the tap of a switch, is known (U.S. Pat. No. 6,873,862 to Reshefsky). However, the Reshefsky '862 patent is drawn to wireless headphones with selective connection to auxiliary audio devices and a cellular telephone. The '862 apparatus specifically has one port for connection to a cell phone which is connected to a switching circuit that when activated by the occurrence of a telephonic connection interrupts the audio from the auxiliary audio appliance.

United States Patent Application 20020067825 to Baranowski, et al. is also somewhat relevant inasmuch as they disclose headphones with a boom microphone that switches on or off when it is extended (allowing selective listening to music or conducting telephonic communications).

Neither of the foregoing nor any other known references teach or suggest the use of a modular assembly or adapter for use with any existing headphones or ear buds, and any existing portable audio devices, nor the detailed schematic implementation of the foregoing.

It would be greatly advantageous to combine the technologies of portable audio players and external microphones to solve the problem of alternating between listening to an audio player and participating in conversation. The present invention combines these technologies and in doing so, it exploits the small size and weight of modern microphones and electronic circuits.

### SUMMARY OF THE INVENTION

Accordingly, it is an object of the present invention to provide a system for allowing a listener of a portable audio player, using earphones cables connecting the audio player to stereo earphones, to converse immediately without removing the earphones.

It is yet another object of the present invention to supplement the existing technologies of portable audio players and external microphones, with a modular assembly for allowing a listener of a portable audio player to depress a momentary switch positioned for quick, easy, and discrete switching between the audio player output and a microphone with ambient sound pickup to allow immediate conversation without removing the earphones.

Another object of the present invention is to provide a system as described above that combines the technologies of portable audio players and external microphones, and that amplifies the microphone signal providing individuals with better hearing than if the earphones were removed, thereby allowing the system to be used as a lightweight assisted listening device for the hearing impaired.

Yet another object of the present invention is to provide a system as described above that positions the microphone at the chest area for optimal speech discrimination.

It is still another object of the present invention to provide a system as described above having a source switch that operates on the powered, low impedance signal from the audio player, preserving sound quality and any matching of player to earphones.

These and other objects are accomplished by a conversation switch for stereo headphones that allow a user to select between listening to an audio player's source (e.g. audio player, computer) and listening to a microphone. The preferred embodiment comprises a standard earphone or headphone set with an additional electronics assembly interposed between the plug and earpieces. The electronics assembly includes a microphone, amplifier, momentary switch, and a latching DPDT relay. The momentary switch functions to toggle the internal relay between the audio source and the microphone amplifier, whereupon ambient sound is picked up by the microphone assembly and is amplified and output to the earphones. The length of cable from the switch assembly to the earpieces is predetermined to allow fixation of the switch assembly at a point situated directly in front of the chest when the user is standing or sitting.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is an assembly drawing of the components of a preferred embodiment of the present invention, where the electronics assembly is at chest level.

FIG. 2 is a rear view of the electronics assembly 2 of FIG. 1.

FIG. 3 is an assembly drawing of the components of an alternate embodiment where the electronics assembly is proximate to the plug.

FIG. 4 is an assembly drawing of the components of an alternate embodiment where the pushbutton switch is housed separately from the other electronic components.

FIG. 5 is a functional block diagram of the preferred embodiment.

FIG. 6 is a functional block diagram of an alternate embodiment wherein the functions of the electronics assembly are performed by components incorporated into the audio player.

FIG. 7 is an assembly drawing of the components of an alternate embodiment using a wired headphone set.

FIG. 8 is an assembly drawing of the components of an alternate embodiment using a wireless headphone set.

### DETAILED DESCRIPTION OF THE PREFERRED EMBODIMENT(S)

The present invention is a system and method for allowing a listener of a portable audio player to immediately converse without removing the earphones.

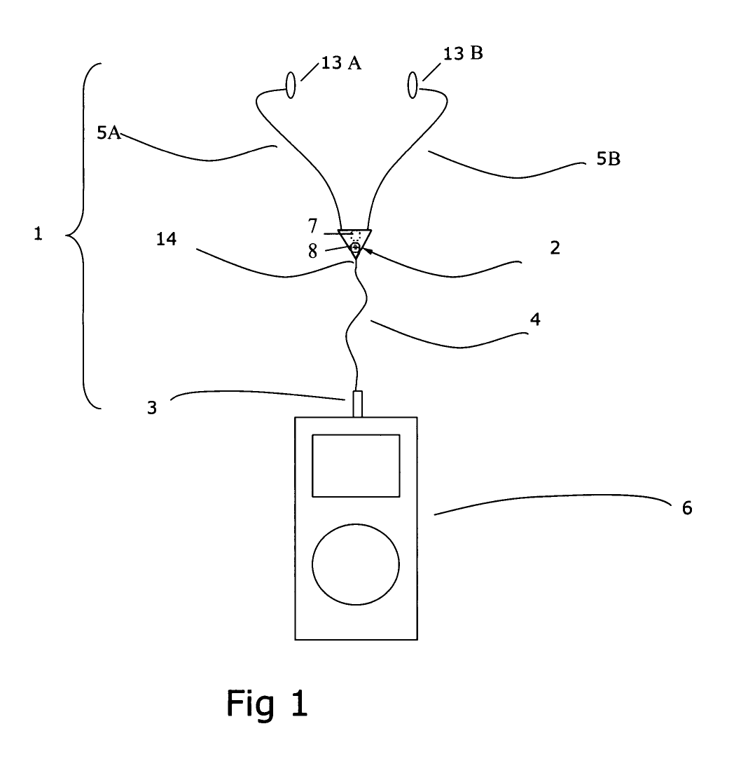

FIG. 1 is an assembly drawing of the components of a preferred embodiment of the present invention. The illustrated embodiment comprises a stereo earphone set 1 incorporating left and right earphones 13A, 13B (any conventional over-or-under the ear phones or buds), earphones 13A, 13B being connected through corresponding stereo cables 5A, 5B to a modular electronics assembly 2 containing a case-mounted microphone 8 and pushbutton 22 (shown here in dotted lines because it is mounted to the rear of the electronics assembly 2). Cables 5A, 5B are joined into a unitary cable 4 at a splitting point 14 (which may be above or below the electronics assembly 2), and cable 4 continues to a standard 3.5 mm male plug 3 for insertion into an audio player 6. The electronics assembly 2 is permanently affixed to all cables 5A, 5B and 4 at or proximate the splitting point 14.

The electronics assembly 2 contains an outwardly-facing microphone 8 and a pushbutton detent switch 7, switch 7 toggling an internal relay inside electronics assembly 2. In the “normal” mode (undepressed) position, the pushbutton switch 7 propagates the outputted audio signal from audio player 6 via the common cable 4 to the earphone cables 5A, 5B on to earphones 13A, 13B. The audio from audio player 6 plays through the earphones 13A, 13B in a normal mode. Conversely, manual depression of the pushbutton switch 7 (or manual depression of the entire electronics assembly 2 to depress the pushbutton switch 7 against the user's chest) toggles the internal relay to a “conversation” mode. In the conversation mode, the internal relay (to be described) disconnects the audio signal propagating in the common cable 4, and routes an amplified microphone signal from microphone 8 to the earphones 13A, 13B.

In use, the stereo plug 3 is plugged into the headphone jack of an existing portable audio player 6. The earphones 13A, 13B are then donned. The lengths of cables 5A, 5B are predetermined such that the electronics assembly 2 is supported by said cables and rests approximately at chest level of the user. If someone speaks to the user while listening to the portable audio player 6, the user can simply depress the pushbutton switch 7 (or the entire electronics assembly 2 to depress the pushbutton switch 7 against the user's chest) to toggle between normal and conversation modes. In the conversation mode, the relay in electronics assembly 2 disconnects the common cable signals, and routes an amplified microphone signal from microphone 8 to the earphones 13A, 13B, whereupon ambient sound is picked up by the microphone 8, is amplified by electronics assembly 2 and is output to the headphones 13A, 13B.

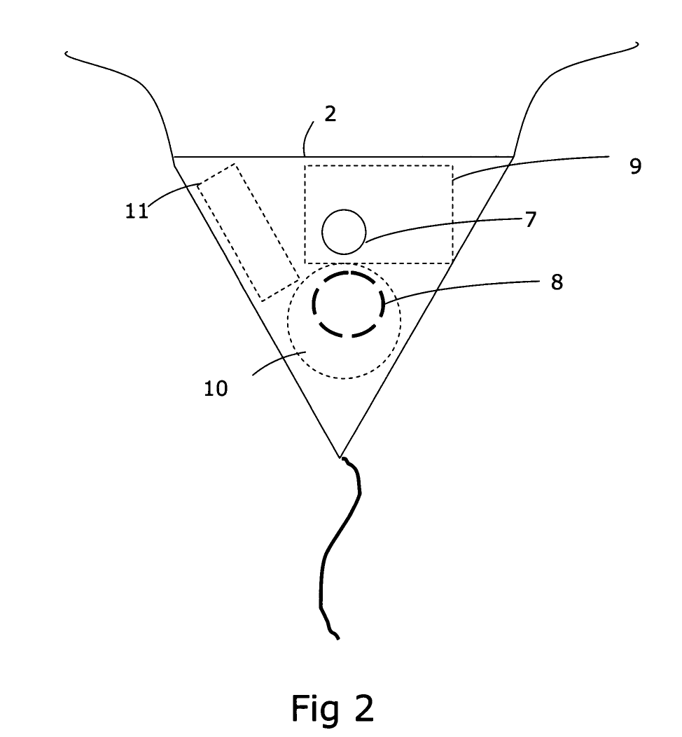

FIG. 2 is a rear view of the electronics assembly 2 of FIG. 1. The pushbutton momentary switch 7 is preferably panel mounted facing the rear of the electronics assembly 2, and the microphone 8 is mounted facing the front. The microphone 8 and momentary switch 7 are electrically connected to a circuit board assembly 9 (described below) containing a miniature latching relay, relay driver, microphone preamp, earphone power amplifier, and control and timing logic. Power is supplied by a battery 10 and a capacitor 11 and this supports short bursts of power for the relay.

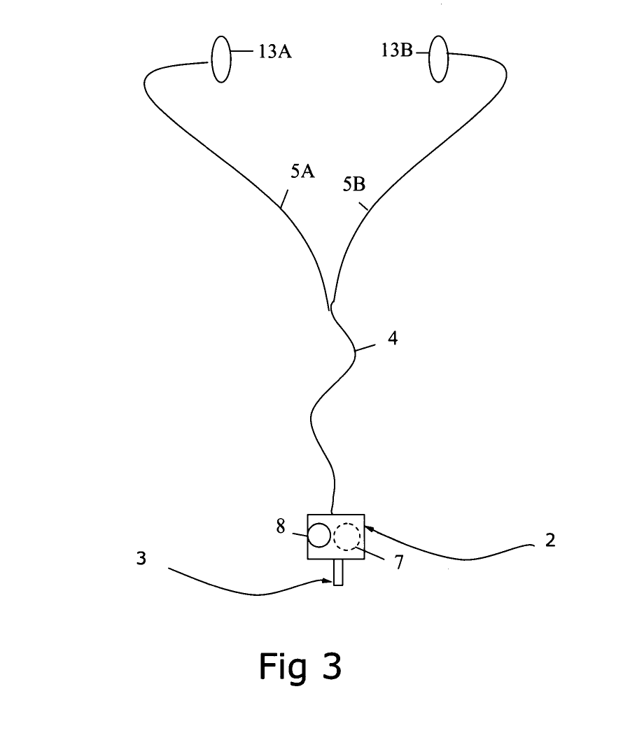

FIG. 3 shows an alternative embodiment in which the electronics assembly 2 is located near the headphone plug 3. This reduces the gravitational and inertial pull on the earphones 13 by supporting the electronics assembly's weight. It has a disadvantage in that the switch and microphone are not as easily reached.

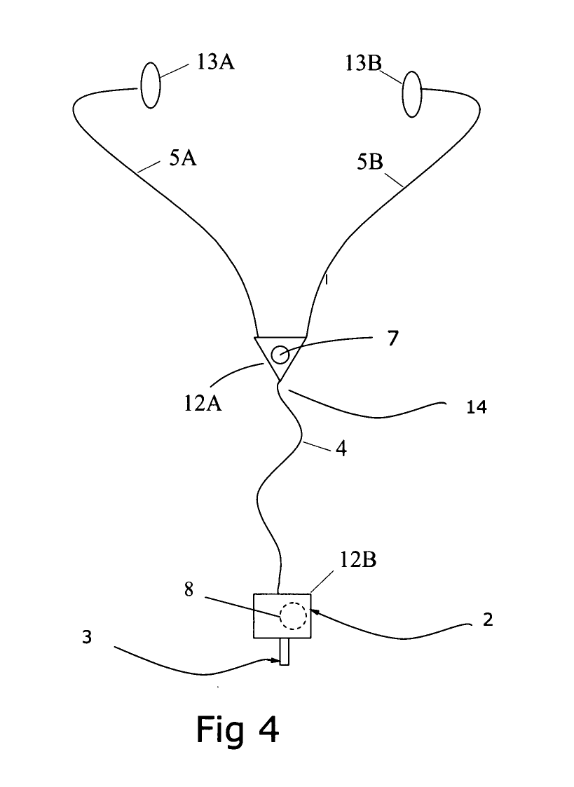

FIG. 4 shows yet another alternative embodiment wherein the pushbutton momentary switch 7 is located remotely in its own separate housing 12A near the splitting point 14 of the earphone cable, while the remaining components of the electronics assembly 2 (sans the switch 7) inclusive of microphone 8, circuit board assembly 9 (containing miniature latching relay, relay driver, microphone preamp, earphone power amplifier, and control and timing logic all as described below) are located in a second housing 12B nearer the plug 3. Thus, for example, the switch housing 12A may be suspended by the discrete stereo cables 5A, 5B approximately at the user's sternum, while the electronics assembly housing 12B may be suspended by the common cable 4 at approximately the user's waist.

In order to implement the embodiment of FIG. 4 an additional conductor wire (additional to the stereo conductor wires) must be added into the common cable 4 to communicate the switch 7 closure to the main electronics assembly 2. This configuration allows easy access to the pushbutton switch 7 while greatly reducing the size and weight supported by the earphones 13A, 13B. It also situates the microphone 8 further from the user's mouth to more evenly equalize the volume of the user's own voice relative to person's around him, such that the user's hears his own voice through earphones 13A & 13B at approximately the same amplitude as those around him. It is also possible to position both the microphone 8 and switch 7 near the splitting point, keeping the main electronics in the electronics assembly 2 near the plug. However, to reduce noise this would require a shielded cable between the two housings, which adds some weight.

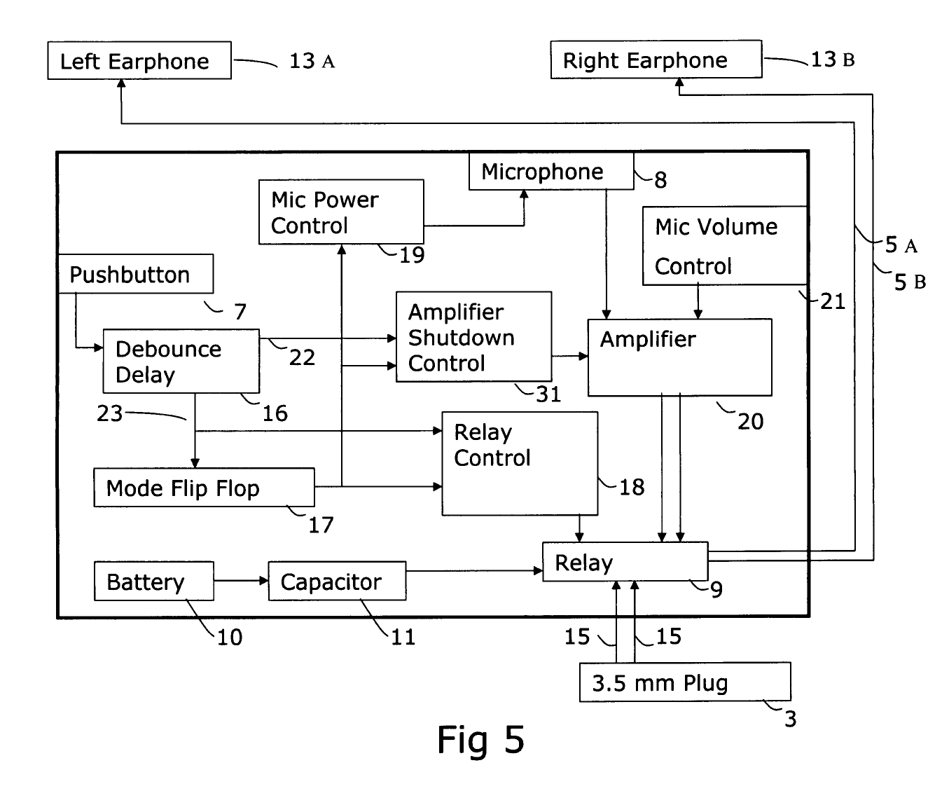

FIG. 5 is a functional block diagram of all embodiments described above in regard to FIGS. 1-4.

Audio signals 15 are received via a 3.5 mm headphone plug 3. In normal mode, the latching relay 9 conducts these signals directly to the earphone cables 5A, 5B and earphones 13A, 13B. When the user wishes to converse, the pushbutton momentary switch 7 activates a one-shot debounce delay circuit 16 that will debounce the switch 7. After the debounce delay time, a mode flipflop 17 is toggled to the conversation mode. This triggers a relay control circuit 18 which pulses the relay 9 to the new position. Power for all circuitry is provided by the battery 10 that is as small as possible to support the circuit with an adequate life. The relay 9 requires a large burst of power for a short time, so a capacitor 11 is used in parallel with the battery to meet this short term need. The mode flip-flop 17 enables a power control circuit 19 for the microphone 8. The flipflop 17 simultaneously triggers a shutdown control circuit 31 that delays activation of a microphone amplifier 20 until power up transients have settled. When both the microphone 8 and amplifier 20 are enabled (conversation mode), the user can converse. An optional volume control 21 may control the microphone 8 volume level. When the user presses the pushbutton switch 7 again, the flipflop 17 returns to the normal state. To avoid the user hearing power-down transients, the shutdown control circuit 31 is reset by the leading edge of the debounce pulse at 22, while the flipflop 17 is toggled by the trailing edge 23. This allows the amplifier 20 to shutdown before the microphone 8 power is removed. The shutdown circuit 31 and state flipflop 17 can be implemented with both halves of a conventional 74HC74 integrate circuit. The debounce delay and relay control timing can be implemented with both halves of a 74HC123 IC. Alternatively, this timing and control logic can be implemented by a programmable gate array, custom integrated circuit, or microprocessor, as a matter of design choice.

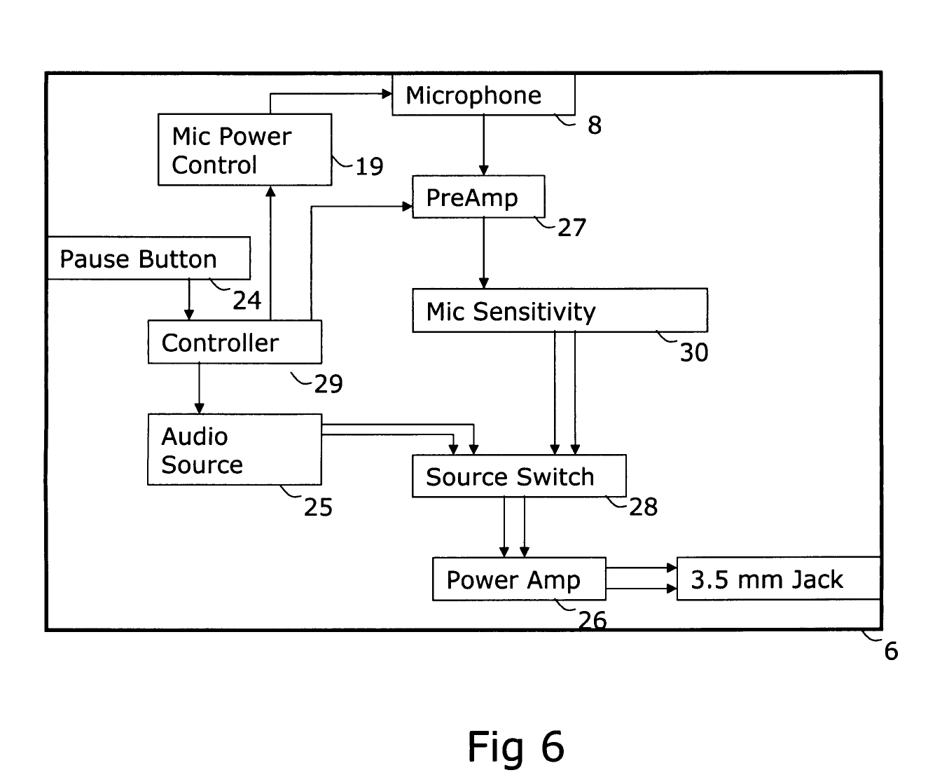

FIG. 6 is a functional block diagram of an alternate embodiment for use with a standard stereo earphone set (not shown), but the audio player 6 has a modified pause function. In typical operation a pause button 24 controls the progress of an audio source 25, and optionally shuts down an earphone power amplifier 26. In this embodiment, the audio player 6 is controlled in the usual manner, but the earphone power amplifier 26 is kept enabled so that a signal from the microphone 8 and a preamp 27 is amplified and conducted to the earphones 13A, 13B. Assuming the audio player 6 contains a microcontroller 29, the timing and logic functions may be implemented thereon by software. Microphone 8 power is provided only when in the paused state. Likewise, the microphone preamp 27 is shutdown until needed. Because the signal source switch 28 is prior to the earphone power amplifier 26, a relay is not required. The source switch 28 is purely electronic and may be analog or digital. An optional microphone sensitivity control 30 can be a circuit controlled by software or the microphone 8 signal can be digitized and the level modified by signal processing software. The timing considerations described for FIG. 5 to mitigate microphone transients are implemented in the controller software.

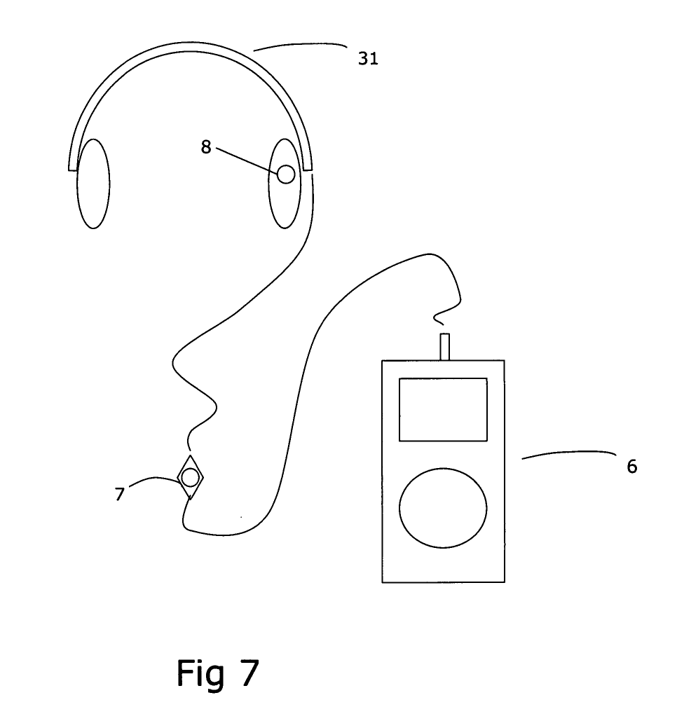

FIG. 7 is an assembly drawing of the components of an alternate embodiment that uses a wired headphone set 31. The pushbutton momentary switch 7 is molded into the headphone cable so that it is within easy reach. Alternatively, it may be mounted in an earpiece. The microphone 8 and all other electronic components are mounted in an earpiece.

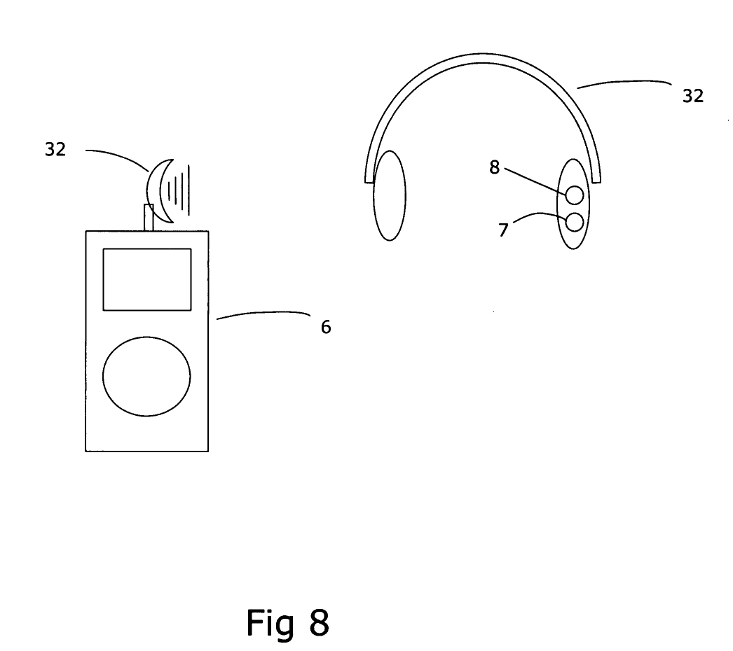

FIG. 8 is an assembly drawing of the components of an alternate embodiment using a wireless headphone set 32. The pushbutton momentary switch 7, the microphone 8 and all other electronic components are mounted in an earpiece.

All of the embodiments discussed are practical designs for implementing the required functions of an on-demand conversation switch. Which embodiment is preferable depends on the cost and size of components and the market appeal of various locations for the switch, microphone, and electronics. The preferred embodiment is distinguished by an optimal tradeoff of these factors based on one set of marketing and technology projections. In all the foregoing cases the present invention allows immediate conversation without removing earphones 13 by pressing a single button that interrupts normal listening and switches in a microphone to the earphones.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. A device for allowing a listener of a portable audio player to listen to said audio player by earphones and to converse without removing the earphones, comprising:
a pair of stereo earphones;
an electronics assembly connected to said earphones, said electronics assembly including a microphone, an amplifier connected to said microphone, a relay and a pushbutton switch for toggling said relay between a normal mode in which a signal propagates from said portable audio player to the pair of stereo earphones, and a conversation mode in which said relay stops the signal from said portable audio player and propagates ambient sound from said microphone through said amplifier and to said pair of stereo earphones.

2. The device according to claim 1, wherein said electronics assembly is suspended by wires from said earphones at approximately chest level.

3. The device according to claim 1, wherein said electronics assembly further comprises a housing, said microphone being panel-mounted on one side of said housing and said pushbutton switch being mounted on another side of said housing.

4. The device according to claim 1, wherein said electronics assembly further comprises a debounce circuit connected to said relay.

5. The device according to claim 1, further comprising a plug for insertion into said audio device, the electronics assembly being connected between said earphones and plug.

6. The device according to claim 1, further comprising a plug for insertion into said audio device, the electronics assembly being attached proximate said plug.

7. An apparatus for allowing a user to selectively listen either to an audio player or amplified ambient sound, comprising:
a set of earphones;
a plug for insertion into an audio player;
an electronics assembly interposed between the plug and earphones, said electronics assembly including a microphone, an amplifier connected to said microphone, a momentary switch, and a relay;
whereby said momentary switch functions to toggle the relay between the audio player and the amplifier, whereupon ambient sound is picked up by the microphone assembly and is amplified and output to the earphones.

8. The device according to claim 7, wherein said electronics assembly is suspended by wires from said earphones at approximately chest level.

9. The device according to claim 7, wherein said electronics assembly further comprises a housing, said microphone being panel-mounted on one side of said housing and said pushbutton switch being mounted on another side of said housing.

10. The device according to claim 7, wherein said Electronics assembly further comprises a debounce circuit connected to said relay.

11. A method for allowing a user to selectively listen either to an audio player or amplified ambient sound, comprising the steps of:
maintaining a normal mode in which sound from the audio player is propagated to earphones; and
depressing a momentary switch to select a conversation mode in which ambient sound is picked up by a microphone assembly, and is amplified and output to said earphones.

12. An apparatus for allowing a user to selectively listen either to an audio player or amplified ambient sound, comprising:
a set of earphones coupled by discrete stereo cables to a common stereo cable;
a momentary switch contained in a first housing attached proximate a branch of said common cable to said discrete stereo cables;
an electronics assembly contained in a second housing attached to said common cable remotely from said first housing, said electronics assembly including a microphone, an amplifier connected to said microphone, and a relay connected between said momentary switch and said amplifier via a wire in said common cable; and
a stereo plug connected to said electronics assembly for insertion into an audio player;
whereby said momentary switch functions to toggle the relay to switch between amplification of an input signal from the audio player and an input signal from said microphone, the latter of which interrupts the input signal from the audio player and causes ambient sound picked up by the microphone to be amplified and output to said earphones.

13. The device according to claim 12, wherein said first housing is suspended by said discrete stereo cables approximately at a user's sternum, and said second housing is suspended by said common cable at approximately said user's waist.

14. The device according to claim 12, wherein said microphone is panel-mounted on one side of said second housing and said momentary switch is mounted on one side of said first housing.

15. The device according to claim 12, wherein said electronics assembly further comprises a debounce circuit connected to said relay.
